(19) United States
(12) Patent Application Publication
(10) Pub. No.: US 2017/0285637 A1
(43) Pub. Date: Oct. 5, 2017

(54) DRIVING ASSISTANCE METHODS AND SYSTEMS

(71) Applicant: GM GLOBAL TECHNOLOGY OPERATIONS LLC, Detroit, MI (US)

(72) Inventors: JEREMY A. SALINGER, SOUTHFIELD, MI (US); AKRAM ABDEL-RAHMAN, AJAX (CA)

(73) Assignee: GM GLOBAL TECHNOLOGY OPERATIONS LLC, Detroit, MI (US)

(21) Appl. No.: 15/473,149

(22) Filed: Mar. 29, 2017

Related U.S. Application Data
(60) Provisional application No. 62/316,363, filed on Mar. 31, 2016.

(51) Int. Cl. G05D 1/00; B60W 50/14; B60W 40/08

(52) U.S. Cl. CPC G05D 1/0061; G05D 1/0011; B60W 40/08; B60W 50/14; B60W 2040/0818

(57) ABSTRACT

Methods and systems are provided for controlling a vehicle. In one embodiment, a method includes: determining, by a processor, unresponsiveness of at least one of a driver and a vehicle system; in response to the determining, communicating, by a processor, a request for remote control to a remote server; in response to the communicating, receiving, by a processor, information from the remote server; and controlling the vehicle by one or more semi-autonomous or autonomous vehicle controls systems based on the received information.

### CROSS-REFERENCE TO RELATED APPLICATIONS

This application claims the benefit of U.S. provisional patent application No. 62/316,363, filed Mar. 31, 2016 which is hereby incorporated by reference in its entirety.

### TECHNICAL FIELD

The technical field generally relates to systems and methods for assisting a driver in operating a vehicle, and more particularly relates to methods and systems for detecting when a driver is unable to operate the vehicle and to operate the vehicle when the driver is unable to operate the vehicle.

### BACKGROUND

An autonomous vehicle is a vehicle that is capable of sensing its environment and navigating with little or no user input. An autonomous vehicle senses its environment using sensing devices such as radar, lidar, image sensors, etc. The autonomous vehicle system further uses information from global positioning systems (GPS) technology, navigation systems, other vehicles, infrastructure, and/or drive-by-wire systems to navigate the vehicle to determine its environment. A semi-autonomous vehicle is a vehicle that is capable of sensing its environment and providing operation assistance while a driver is operating the vehicle. The semi-autonomous vehicle uses the same or similar information to sense its environment.

In some instances, a driver of a vehicle may become unable to continue to operate the vehicle. If the vehicle is in motion during such instances, it is desirable for the semi-autonomous vehicle to be able to operate without the use of driver input, such as to operate as an autonomous vehicle. In some instances, an autonomous vehicle may determine that it is unable to operate without some additional information. In such instances, a driver may not be able to provide such feedback. Accordingly, it is desirable to provide methods and systems for determining when a driver is unable to provide a response. It is further desirable to provide methods and systems for operating the vehicle when it is detected that the driver is unable to provide a response. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for controlling a vehicle. In one embodiment, a method includes: determining, by a processor, unresponsiveness of at least one of a driver and a vehicle system; in response to the determining, communicating, by a processor, a request for remote control to a remote server; in response to the communicating, receiving, by a processor, information from the remote server; and controlling the vehicle by one or more semi-autonomous or autonomous vehicle controls systems based on the received information.

### DESCRIPTION OF THE DRAWINGS

The exemplary embodiments will hereinafter be described in conjunction with the following drawing figures, wherein like numerals denote like elements, and wherein:

FIG. 1 is functional block diagram of a vehicle having a driver assistance system in accordance with various embodiments;

FIG. 2 is an illustration of a remote assistance screen used in providing remote assistance in accordance with various embodiments; and

FIG. 3 is a sequence diagram illustrating a driver assistance control method in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of steering/propulsion control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

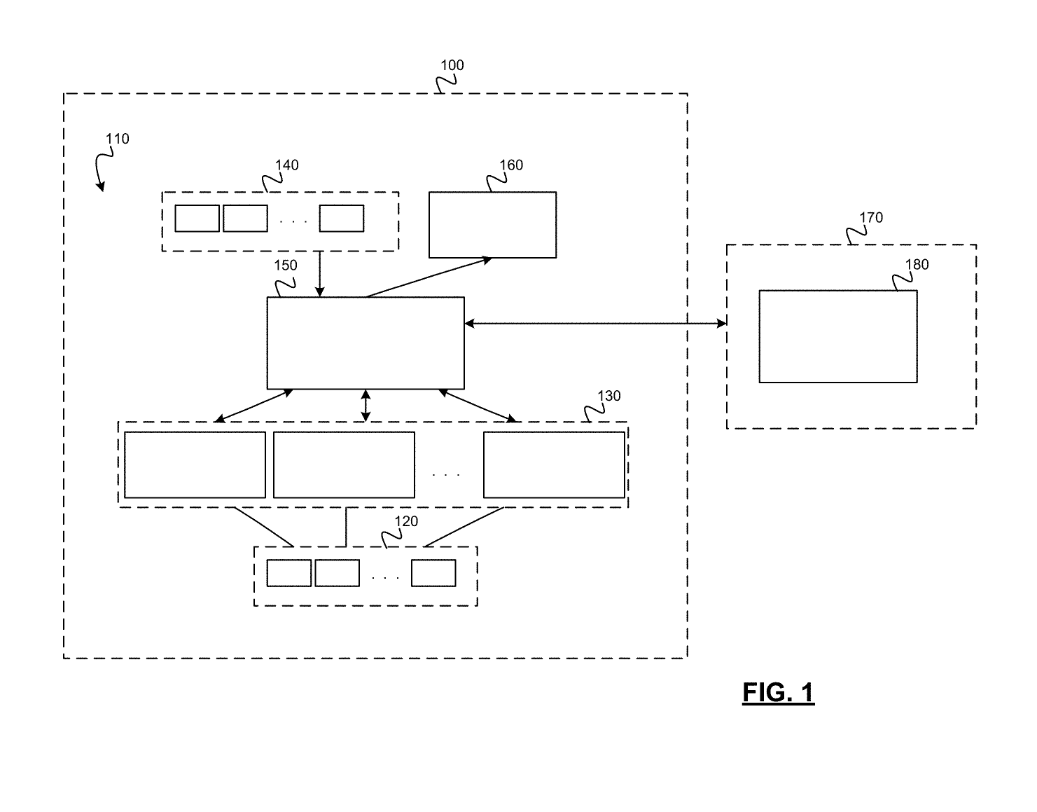

With reference to FIG. 1, an exemplary vehicle 100 is shown that includes a driver assistance system 110 in accordance with exemplary embodiments. As can be appreciated, the vehicle 100 may be any vehicle type including but not limited to, an automobile, a sport utility vehicle, a watercraft, an aircraft, etc. Although the figures shown herein depict an example with certain arrangements of elements, additional intervening elements, devices, features, or components may be present in actual embodiments. It should also be understood that FIG. 1 is merely illustrative and may not be drawn to scale.

In various embodiments, the vehicle 100 is a semi-autonomous vehicle. As can be appreciated, the vehicle 100 can be any type of vehicle including, but not limited to a conventional vehicle or an autonomous vehicle as the disclosure is not limited to semi-autonomous vehicles. In various embodiments, the semi-autonomous vehicle 100 includes, among other features, one or more exterior sensors 120 that sense an element of an environment of the vehicle 100 and that generate sensor signals that are used to control one or more functions of the vehicle 100 to partially drive the vehicle 100. For example, the sensor signals are used by one or more control systems 130 of the vehicle 100 to control actuators that control driving functions of the vehicle 100. When the vehicle 100 is an automobile, the control systems 130 can include, but are not limited to, a parking system, a vehicle cruise system, a lane keeping system, a lane change system, a vehicle steering system, etc. As can be appreciated, the control systems 130 described herein are merely exemplary, as any control system associated with providing full or partial autonomy can be included, in various embodiments. In various embodiments, the control systems 130 are semi-autonomous in that they rely on driver input for situations when the sensors 120 and/or the control system 130 are incapable of sensing and/or controlling the driving functions for the driving condition.

The driver assistance system 110 that is associated with the semi-autonomous vehicle 100 generally includes one or more internal sensors 140, an assistance manager module 150, a notification system 160, and a remote server 170. The internal sensors 140 sense observable conditions of the driver. For example, the internal sensors 140 can include, but are not limited to, image sensors, speech sensors, touch sensors, switches, buttons, or other sensors that directly or indirectly interface with the driver and that generate sensor signals based thereon. The notification system 160 presents information to the driver. The notification system 160 presents the information via one or more audio devices, one or more visual devices, one or more haptic devices, and/or any combination thereof.

In various embodiments, the assistance manager module 150 is communicatively coupled to the control systems 130, the internal sensors 140, and the notification system 160 (e.g., either directly or through a vehicle communications network, or other communication means). The assistance manager module 150 monitors communications between the control systems 130 and the notification system 160 for requests for a driver response (in the case of a semi-autonomous vehicle) or alternatively a request for confirmation of a maneuver (e.g., change lanes to the left, change lanes to the right, turn left at the next intersection, turn right into a driveway, slow to a stop, park, etc.) from another control system (in the case of an autonomous vehicle), and monitors communications or sensor signals from the internal sensors 140 (or other controls systems) to the control systems 130 to determine whether a driver (or other control systems) is responsive or unresponsive to the requests. For example, the assistance manager module 150 monitors one more of the communications or sensor signals from the internal sensors 140 after a response of the driver is requested via a communication to the notification system 160, and if no communication or sensor signal is received (e.g., within a predefined time period, after a number of requests has been generated, or other criteria) from some expected internal sensors 140, the assistance manager module 150 determines that the driver is unresponsive. In various embodiments, the assistance manager module 150 further evaluates data from some of the sensor signals (e.g., image data or other data) to confirm that the driver is unresponsive (e.g., the driver's movement (facial or other body element) is minimal, the driver's attention is away from the notification or the requested action, etc.).

As can be appreciated, when the vehicle 100 is an autonomous vehicle, the request for a response may be communicated to another control system (not shown) or simply communicated directly to the assistance manager module 150. In such examples, the assistance manager module 150 determines unresponsiveness by determining that the other control system is unresponsive, that no control system is able to respond to such a request, or that a driver (or other user) fails to respond.

The assistance manager module 150 is further communicatively coupled to the remote server 170 (e.g., through a satellite communication network, or other communication means). When it is determined that the driver (or other control system) is unresponsive, the assistance manager module 150 communicates information to and receives information from the remote server 170. For example, when it is determined that the driver (or other control system) is unresponsive, the assistance manager module 150 communicates a request for remote control to the remote server 170. The request for remote control can include context information, such as, but not limited to, a current location of the vehicle 100, a traveling path of the vehicle 100, a vehicle identification number, driver information, etc.

In response to the request for remote control, the assistance manager module 150 receives control instructions from the remote server 170. The control instructions can include, for example, but are not limited to, coordinates of a location to bring the vehicle to a stop (e.g., a side of the road, a parking lot, etc.), operation instructions (e.g., vehicle speed, steering commands, etc.) for bringing the vehicle to a stop or perform some other maneuver, and/or notification information for notifying the driver of the remote control and/or the location/maneuver. The assistance manager module 150 then communicates the information from the control instructions to the appropriate control system 130 and/or the notification system 160. The control system or systems 130 operate the vehicle 100 based on the information such that the vehicle 100 comes to a stop at the location or performs the other maneuver. The notification system 160 notifies the driver of the remote control based on the information.

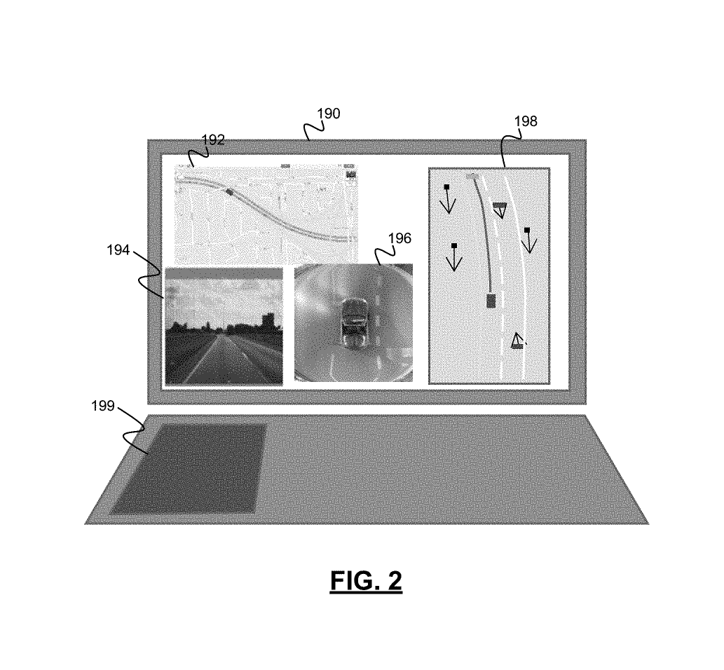

In various embodiments, the remote server 170 includes a remote control module 180. The remote control module 180 receives the request for remote control from the vehicle 100 and processes the request to determine a location for bringing the vehicle 100 to a stop or to determine some other driving maneuver. For example, the location can be automatically determined from the vehicle's current location and traveling path and map data indicating safe locations to stop. In such example, the remote control module 180 compares the vehicle's current location to safe locations indicated in the traveling path and selects the closest safe location. In another example, the location can be determined by a user of the remote server 170. For example, a user may interact with a user interface of the remote control module 180. An exemplary user interface 190 is shown in FIG. 2. The user interface 190 includes, in various embodiments, a screen 192 that shows in realtime the vehicle's location relative to a map, one or more screens 194, 196 that show realtime video footage obtained by the vehicle sensors, and at least one screen 198 that includes an image produced from the data of the other sensors indicating the vehicle's current location, position, and driving direction of the vehicle on the roadway and/or of other vehicles or obstacles. In such example, the user evaluates the content of the screens and makes a selection via a keypad 199 or other input device of the safe location closest (or other location) to the vehicle's location and in the traveling path and/or driving maneuvers that can be performed safely.

With reference back to FIG. 1, based on the selected location and/or other maneuvers, the remote control module 180 determines operation instructions (e.g., vehicle speed, steering commands, etc.) for bringing the vehicle 100 to a stop or for performing the maneuver, and notification information for notifying the driver of the remote control and/or the location/maneuver. The remote control module 180 then communicates back to the vehicle 100 the coordinates of the location to bring the vehicle 100 to a stop, operation instructions (e.g., vehicle speed, steering commands, etc.) for bringing the vehicle 100 to a stop or other maneuver, and/or notification information for notifying the driver of the remote control and/or the location/maneuver.

In various embodiments, in addition to or as an alternative to determining operation instructions for a maneuver, the remote control module 180 determines operation instructions for activating one or more control systems 130 to warn the surroundings of the unresponsive driver. For example, the operation instructions can control a horn, control interior or exterior lights of the vehicle, control seat-belt pre-tensioning, control driver seat orientation, etc.

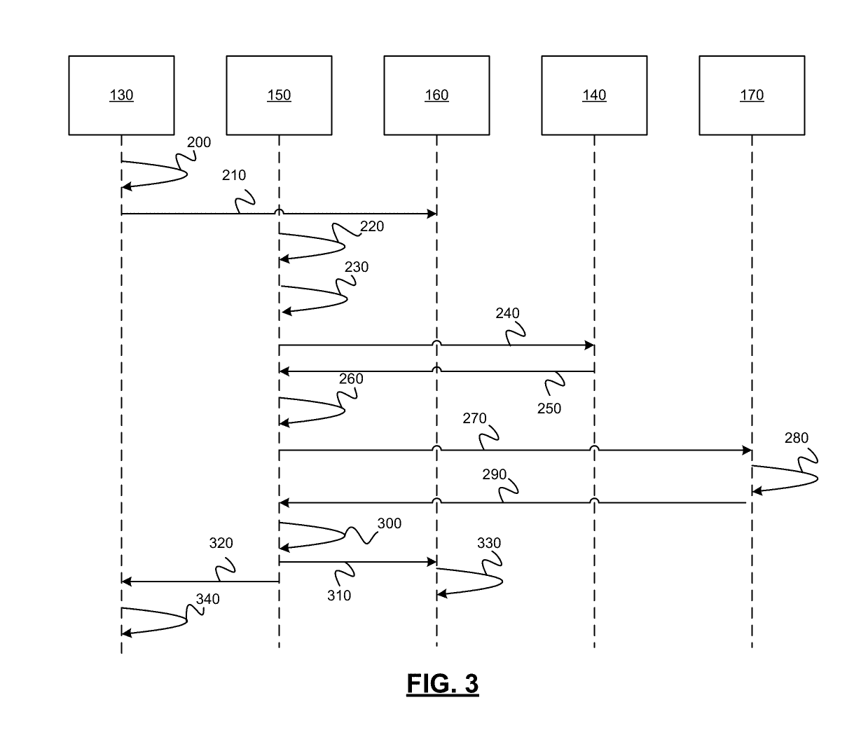

Referring now to FIG. 3, a sequence diagram illustrates driver assistance methods that may be performed by the modules and/or systems of FIG. 1 in accordance with various embodiments. As can be appreciated in light of the disclosure, the order of operations within the methods is not limited to the sequential execution as illustrated in FIG. 2, but may be performed in one or more varying orders as applicable and in accordance with the present disclosure. As can further be appreciated, one or more steps of the method may be added or removed without altering the spirit of the method.

As shown, one or more control systems 130 are operating to control the vehicle 100. At least one of the control systems 130 determines that it requires a driver response at 200. The request for a driver response is communicated to the notification system 160 at 210 to notify the driver. The assistance manager module 150 monitors the communications at 220 and determines that a request for driver response has been sent. The assistance manager module 150 monitors for sensor signals and/or communications from the internal sensor(s) 140 back to the requesting control system at 230. If no sensor signals and/or communications are received, then it is determined that the driver is unresponsive at 230. Optionally, the assistance manager module 150 requests additional data from the internal sensors at 240. In response, the internal sensor(s) provide image data to the assistance manager module 150. The assistance manager module 150 processes the image data to confirm that the driver is unresponsive at 260. As can be appreciated, in various embodiments, any one of steps 210-260 can be repeated any number of times before the assistance manager module 150 determines that the driver is unresponsive. As can further appreciated, other methods of confirming that the driver is unresponsive can be implemented in various embodiments, as steps 220-260 are merely exemplary.

At 270, the assistance manager module 150 communicates a request for remote control to the remote control module 170. The remote control module 170 receives the request and determines a location to stop the vehicle 100 at 280. The remote control module 170 communicates the stop location and any additional information to the assistance manager module 150 at 290. The assistance manager module 150 receives the information and communicates the information to the notification system 160 at 310 and to the control system 130 at 320. The notification system 160 notifies the driver of the remote control and the location that the vehicle 100 will be stopped at 330. The control system(s) 130 control the vehicle 100 to stop at the location based on the information at 340.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
determining, by a processor, unresponsiveness of at least one of a driver and a vehicle system;
in response to the determining, communicating, by a processor, a request for remote control to a remote server;
in response to the communicating, receiving, by a processor, information from the remote server; and
controlling the vehicle by one or more semi-autonomous or autonomous vehicle controls systems based on the received information.

2. The method of claim 1, wherein the determining the unresponsiveness is based on a monitoring of communications between control systems and a notification system.

3. The method of claim 2, wherein the monitoring is for communications that include a request for a driver response.

4. The method of claim 2, wherein the monitoring is for communications that include a request for confirmation of a maneuver.

5. The method of claim 2, wherein the monitoring is for a lack of communication from a sensor or control system in response to a request.

6. The method of claim 1, wherein the determining the unresponsiveness is further based on an evaluation of image data associated with the driver.

7. The method of claim 1, wherein the determining the unresponsiveness is based on a monitoring of communications between control systems.

8. The method of claim 7, wherein the determining the unresponsiveness is based on a determination that the control systems are unresponsive.

9. The method of claim 7, wherein the determining the unresponsiveness is based on a determination that no control system is able to respond to a request.

10. The method of claim 7, wherein the determining the unresponsiveness is based on a determination that a user has failed to respond.

11. The method of claim 1, wherein the information from the remote server includes at least one of coordinates of a location to bring the vehicle to a stop, operation instructions for bringing the vehicle to a stop, and notification information for notifying the driver of the remote control.

12. A system for controlling a vehicle, comprising:
an assistance manager module that determines, by a processor, that a confirmation of a vehicle maneuver is not received, that communicates, by the processor, a request for remote control to a remote server, that receives, by the processor, information from the remote server; and
at least one semi-autonomous or autonomous control module that controls the vehicle based on the received information.

13. The system of claim 12, wherein the assistance manager module determines that a confirmation is not received based on a monitoring of communications between control systems and a notification system.

14. The system of claim 13, wherein the assistance manager module determines that a confirmation is not received based on a monitoring for communications that include a request for a driver response.

15. The system of claim 13, wherein the assistance manager module determines that a confirmation is not received based on a monitoring for communications that include a request for confirmation of a maneuver.

16. The system of claim 13, wherein the assistance manager module determines that a confirmation is not received based on a monitoring for a lack of communication from a sensor or control system in response to a request.

17. The system of claim 13, wherein the assistance manager module determines that a confirmation is not received based on an evaluation of image data associated with the driver.

18. The system of claim 12, wherein the assistance manager module determines that a confirmation is not received based on a monitoring of communications between control systems.

19. The system of claim 18, wherein the assistance manager module determines that a confirmation is not received based on at least one of a determination that the control systems are unresponsive, a determination that no control system is able to respond to a request, and a determination that a user has failed to respond.

20. The system of claim 12, wherein the received information includes at least one of coordinates of a location to bring the vehicle to a stop, operation instructions for bringing the vehicle to a stop, and notification information for notifying the driver of the remote control.
